(19) United States
(12) Patent Application Publication
(10) Pub. No.: US 2017/0231411 A1
(43) Pub. Date: Aug. 17, 2017

(54) REUSABLE LABELS FOR INFANT'S BOTTLES OR CHILDREN'S CUPS

(71) Applicant: Amy Rebecca Brown Boyle, Indianapolis, IN (US)

(72) Inventor: Amy Rebecca Brown Boyle, Indianapolis, IN (US)

(21) Appl. No.: 15/586,828

(22) Filed: May 4, 2017

Related U.S. Application Data
(63) Continuation of application No. 14/563,090, filed on Dec. 8, 2014, now abandoned.
Application No. 14/563,090 is a continuation of application No. 14/042,764, filed on Oct. 1, 2013, now abandoned.
(60) Provisional application No. 61/708,204, filed on Oct. 1, 2012.

(51) Int. Cl. A47G 19/22; A61J 9/00; G09F 3/14; B65D 25/20; G09F 3/20; G09F 3/02

(52) U.S. Cl. CPC A47G 19/2227; G09F 3/20; G09F 3/02; G09F 3/14; B65D 25/205; A61J 9/00; G09F 2003/0272; G09F 2003/0273

(57) ABSTRACT

A reusable label for infant's bottles or children's cups, comprising a band section and a label section each made from a flexible material, the band section having a male plastic snap at one end thereof with a plurality of female plastic snaps at the other end thereof for securing the band section around an infant's bottle or children's cup, and the label section being in the middle of the band section with the flexible plastic material thereof being removably markable with dry-erase and wet-erase markers for imparting thereto infant or child identifications and prescriptive caretaker information.

### BACKGROUND OF THE INVENTION

When a parent needs to rely on a third party to care for their infant or child, they often must provide to that caretaker specific instructions for bottles and mealtimes, whether the caretaker is a licensed day-care facility, a babysitter, or a relative. Many such settings, such as a licensed day-care facility, are very prescriptive regarding the type of information that must accompany the infant's bottle or child's cup. For example, they all must know what time breast milk or formula was expressed or mixed, the name of the infant or child to whom the bottle or cup belongs, and at what time the infant or child is to be fed.

Today, parents often resort to a number of unsatisfactory labeling methods to accomplish the transfer of such information to caretakers. Parents are using masking tape, mailing labels, permanent markers applied directly to the infant's bottle or child's cup, or they use sticky notes. These methods are less-than-ideal because they are either unreliable (i.e., they fall-off), they are overly sticky and therefore do not come off the bottle or cup without significant effort and without leaving residue, or they are unable to be changed at all from day-to-day. In the case of any paper-type labels, they are not reusable, which increases expenses and is otherwise bad for the environment.

Furthermore, the labeling methods used today are not distinctive in either their style or colors, which makes identifying one infant's bottle or child's cup from others difficult without close examination of the information that accompanied the infant's bottle or child's cup.

### BRIEF SUMMARY OF THE INVENTION

Parents need a labeling solution that is reusable, washable, that withstands temperature changes and condensation, and that contains all the necessary information to ensure a caretaker can care for their infant or child according to the parent's instructions.

The reusable labels for infant's bottles or children's cups of the present invention provide the solution needed because they wrap-around an infant's bottle or children's cup and are secured thereto by a snap. They are made of pliable, molded plastic material and are therefore reusable and washable. Both dry-erase and wet-erase markers are effective writing utensils for using with the reusable labels of the present invention because the ink “holds” to the plastic material of construction, but the ink is easily removed from the reusable labels with water and/or soap. the reusable labels for infant's bottles or children's cups of the present invention can also easily be machine-washed. They can come in a variety of colors and designs, which makes the infant's bottle or children's cup stand-out and be very distinctive in any caretaker venue. The reusable labels for infant's bottles or children's cups of the present invention also provide security to parents and to caretakers because the necessary prescriptive information is reliably communicated.

### BRIEF DESCRIPTION OF THE SEVERAL VIEWS OF THE DRAWINGS

FIG. 1 is a color photograph of a preferred embodiment of the reusable labels of the present invention with the label section in the form of a 3-dimensional football.

FIG. 2 is a color photograph of a preferred embodiment of the reusable labels of the present invention with the label section in the form of a 3-dimensional planet.

FIG. 3 is a color photograph of a preferred embodiment of the reusable labels of the present invention with the label section in the form of a 3-dimensional red ladybug.

FIG. 4 is a color photograph of a preferred embodiment of the reusable labels of the present invention with the label section in the form of a 3-dimensional baseball.

FIG. 5 is a color photograph of a preferred embodiment of the reusable labels of the present invention with the label section in the form of a 3-dimensional red flower.

FIG. 6 is a color photograph of a preferred embodiment of the reusable labels of the present invention with the label section in the form of a 3-dimensional yellow flower.

FIG. 7 is a color photograph of a preferred embodiment of the reusable labels of the present invention with the label section in the form of a 3-dimensional green ladybug.

FIG. 8 is a color photograph of a preferred embodiment of the reusable labels of the present invention with the label section in the form of a 3-dimensional yellow sun.

FIG. 9 is a color photograph of a typical drip-molding machine.

### DETAILED DESCRIPTION OF THE INVENTION

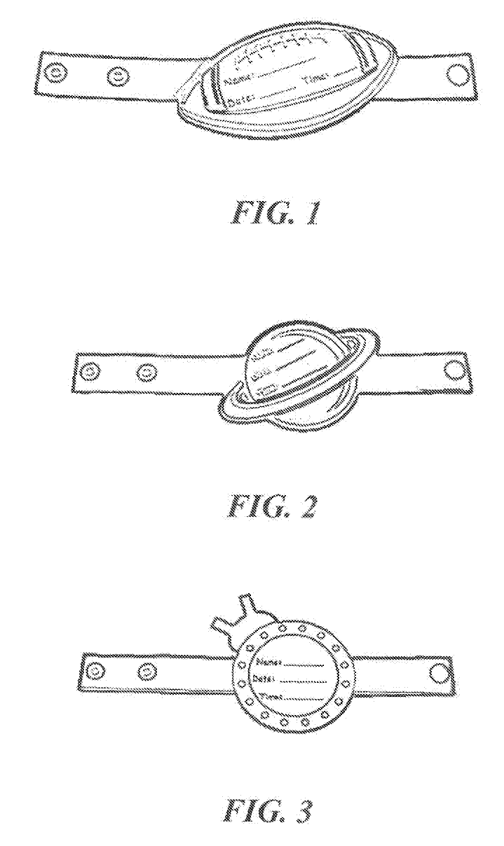

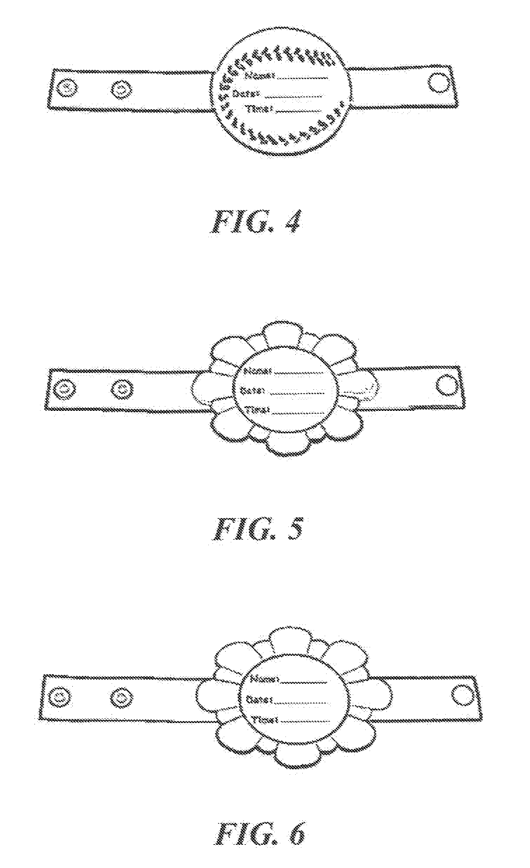

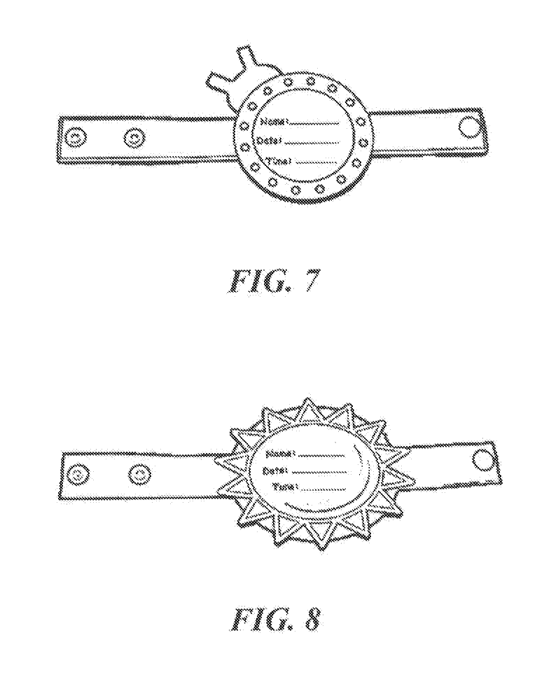

Referring now the FIGS. 1-8, in the preferred embodiments to date of the reusable labels for infant's bottles or children's cups of the present invention, the following steps are followed to place the labels of the invention into practice:

1. Lay the reusable infant's bottle or children's cup label of the present invention print-side up, on a flat and clean surface.

2. Using a dry-erase or wet-erase type marker, write the necessary prescriptive infant's or child's caretaking information on the label in the appropriate spaces.

3. Allow 30 seconds for the ink to dry.

4. Wrap the reusable label for an infant's bottle or children's cup of the present invention around an infant bottle or children's cup, print-side out, and secure the label to the bottle or cup with the snap provided on the reusable labels for infant bottles or children's cups of the present invention.

5. When you are done using the infant's bottle or children's cup, remove the reusable label of the present invention by un-snapping it from the back of the infant bottle or children's cup.

6. Remove the ink from the reusable label for an infant's bottle or children's cup of the present invention with soap and water or in a machine dishwasher.

The reusable labels for an infant's bottle or children's cup of the present invention are practical and attractive when applied to an infant's bottle or children's cup, and they are reusable and washable, and they will stand-up to freezing, refrigeration and condensation.

The reusable labels for an infant's bottle or children's cup of the present invention are a one-piece, multi-colored, flexible PVC labeling system for use with infant bottles and children's cups.

Referring to the drawings, the labels of the preferred embodiments to date consist of a band section and a label section. The band section is used to secure the label to the bottle/cup, and it has matte finish. The preferred band section to date has a length of 231 mm and is 25 mm in width. The band section has an overall thickness of 1 mm. Integrated within the band section are a total of four (4) plastic snaps. A male snap will be located near one end of the band section at a distance of 9 mm from its end point, and it will be centered in the width of the band at the location. Three female snaps will be located near the opposite end of the band section, with center-to-center distances from the male snap of 182 mm, 197.5 mm, and 212 mm, respectively. The three female snaps are also be centered in the width of the band section at those locations. To accommodate new designs of baby bottles and children's cups, additional snaps may be added; and the band may be adjusted in length and width.

The label section is located at the center of the band section and is used for imparting caretaker prescriptive information and identifications to the bottle/cup. The label section has a glossy finish, and the material chosen allows use of dry-erase and wet-erase-type markers to leave their marks upon the label section, where they will remain until removed with a damp cloth. The label sections in the preferred embodiment to date are made to replicate acceptable artistic designs for infants and children. A sampling of acceptable designs for infant's bottles and children's cups include, but are not limited to, a flower, a butterfly, a ladybug, a baseball, a basketball, a football (US), a soccer ball (US), a planet and a sun, exemplary samples of which are illustrated in FIGS. 1-8.

The label section may also include raised portions of within the design, which serve to enhance the design aesthetic. The label section may also include raised lettering, including “Name:”; “Date:”; and “Time:”. In preferred embodiments to date, the raised portions of the label section will protrude 1/32 of and inch off the face of the label section. The label section will have an overall thickness of 1/16 of an inch. Additional designs may be created around themes including, but not limited to, sports, holidays, animals, nature, and automobiles. Baby and children designers will continue to develop new attractive and appropriate designs for the label section of the present invention.

Photos of exemplary reusable labels for infant's bottles or children's cups of the present invention are included in FIGS. 1-8.

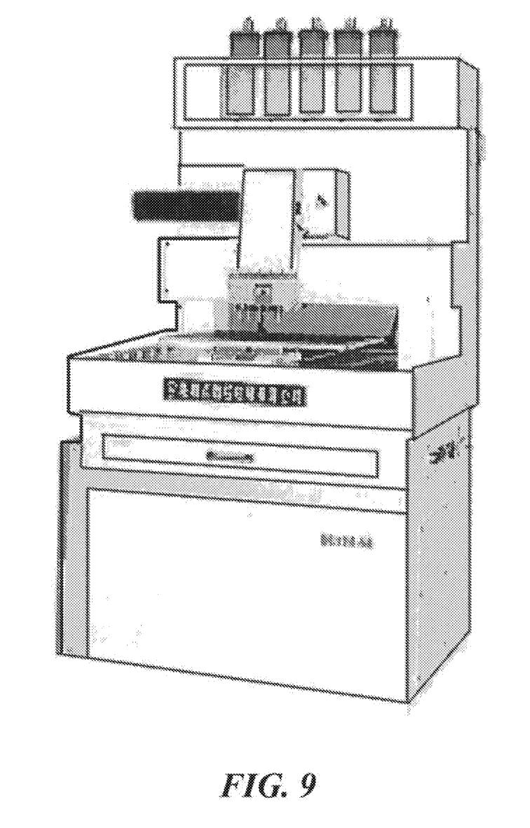

The process used to create the preferred embodiments to date of the reusable labels for infant's bottles or children's cups of the present invention is called drip-molding. To drip-mold, one must start with a commercial drip-molding machine. See FIG. 9.

The preferred material to date to use to make the reusable labels for infant's bottles or children's cups of the present invention is liquid polyvinyl chloride (PVC). One can see 5 barrels on the top of the drip-molding machine of FIG. 9. These barrels are filled with the liquid PVC, each of a different color. There are 5 release nozzles right on the drip-molding machine. Each of these nozzles is connected to one of the 5 barrels of liquid PVC by a tube.

Now referring to the reusable label for infant's bottles or children's cups of the present invention with a yellow flower on a pink strap of FIG. 6, it will be used to explain how the drip-molding process was used to create it.

A tool is created for the reusable labels for an infant's bottle or children's cup of the present invention, which is typically made of a brass plate. A tool-maker carves the plate according to design chosen for the label. The tool maker carves the key label identification features face down: Name:, Date:, Time:, and the petals first, then the white center of the flower, then the pink background, and then the strap.

The tool is placed underneath the nozzles of the drip-molding machine. See FIG. 9. One of the nozzles will drip yellow PVC into the tool to create the petals, another nozzle will drip pink PVC into the engraved letters to create Name:, Date:, and Time. After this, the tool will be baked for a couple of minutes at 200 degrees C., so that the PVC will solidify. Then the tool is moved back underneath the nozzles to have the white center of flower dripped, followed by another round of baking. The last layer—the pink base and straps—will be dripped, followed by final round of baking.

The drip-molding machine is computer programmed, so the tool is moved by the machine sideways to catch the colored PVC drops at just the right locations. Also, when the letters are too fine, the nozzles become useless, and the machine worker will have to drip the colored PVC material by hand. Also, the machine worker will have to wipe off the spillage of material from time to time before each baking time. Although the drip-molding machine is programmed, it is not always trusted. The machine worker tends not to have the machine drip different colors into two neighboring compartments in one step. For example, although the bigger light yellow petals and the smaller dark yellow petals are on the same levels, the machine worker will do the light yellow ones first, wipe off spillage, bake it, and then do the light yellow petals. Otherwise, the light yellow drip may mix up with the dark yellow drip and make an undesired combination of colors.

1.-5. (canceled)

6. An apparatus, comprising:
a container configured to hold and dispense a liquid; and
a reusable label configured for us with the container, the reusable label comprising:
a flexible band section comprising a first end and a second end, the flexible band section having a length greater than a circumference of the container;
a first snap coupled to the first end;
a plurality of second snaps coupled to the second end, wherein each of the second snaps is configured to releasably engage the first snap;
a flexible label section formed between the first end and the second end, the flexible label section comprising pre-printed identifying indicia and a three-dimensional design, and being removably markable with dry-erase and wet-erase markers, wherein the pre-printed identifying indicia relates to an information category,, and wherein the flexible label section further comprises a blank space adjacent the pre-printed indicia and configured to receive from the dry-erase and wet-erase markers removable identification markings corresponding to the information category;
wherein the flexible label section has a plurality of widths, the three-dimensional design is defined at least in part by the plurality of widths, and at least some of the plurality of widths are greater than a width of the flexible band section.

7. The apparatus of claim 6, wherein the container comprises one of an infant bottle and a children's cup.

8. The apparatus of claim 7, wherein the pre-printed identifying indicia comprises raised lettering.

9. The apparatus of claim 6, wherein the three-dimensional design is selected from the group consisting of a flower, a butterfly, a ladybug, a baseball, a basketball, a football, a soccer ball, the earth, a planet, then sun, a comet, an elephant, an owl, a peacock, a fish, a race car, a farm tractor, a dump truck, an airplane, a beach sandal, a beach sand pail, a porpoise, and a crab.

10. The apparatus of claim 6, wherein the label section comprises raised portions of the three-dimensional design.

11. The apparatus of claim 6, wherein the flexible label section and the flexible band section are integrally formed with one another.

12. The apparatus of claim 6, wherein each of the flexible label section and the flexible band section are formed of a single flexible material.

13. The apparatus of claim 12, wherein the flexible material is flexible polyvinyl chloride (PVC).

14. The apparatus of claim 13, wherein the ban section has a matte finish and the label section has a glossy finish.

15. The apparatus of claim 6, wherein the flexible label section is formed in the middle of the flexible band section.

16. The apparatus of claim 15, wherein the first snap is a male snap and each of the second snaps is a female snap.

17. The apparatus of claim 15, wherein the first snap is a male plastic snap and each of the second snaps is a female plastic snap.

18. The apparatus of claim 6, wherein the flexible label section further has a plurality of thicknesses, and the three-dimensional design is further defined by the plurality of thicknesses of the flexible label section.

19. The apparatus of claim 6, wherein the container is associated with an infant or child, a first of the pre-printed indicia relates to a name of the infant or child, and a second of the pre-printed indicia relates to a time at which the container is to be given to the infant or child.

20. A method of utilizing the apparatus of claim 19, the method comprising:
writing on the flexible label section, with an erasable marker, information relating to the pre-printed identifying indicia, wherein writing the information includes:
writing, adjacent the first indicia, the name of the infant or child; and
writing, adjacent the second indicia, the time at which the container is to be given to the infant or child; and
securing the reusable label to the container, the securing comprising wrapping the flexible band section around the container, and engaging the first snap with one of the second snaps.

21. A method of utilizing the apparatus of claim 7, the method comprising:
writing on the flexible label section, with an erasable marker, information relating to the pre-printed identifying indicia;
securing the reusable label to the container, the securing comprising wrapping the flexible band section around the container, and engaging the first snap with one of the second snaps.

22. The method of claim 21, wherein the information comprises the name of a child to whom the container belongs and at what time the child is to be fed.

23. A system, comprising:
a plurality of reusable labels, wherein each of the reusable labels is associated with an infant or child, each of the reusable labels comprising:
a flexible band section comprising a first end and a second end, the flexible band section having a length greater than a circumference of a container corresponding to the infant or child associated with the reusable label;
a first snap coupled to the first end;
a second snap coupled to the second end, wherein the first snap is configured to releasably engage the first snap with the flexible band section wrapped about the container to releasably couple the reusable label to the container; and
a flexible label section formed between the first end and the second end, the flexible label section comprising pre-printed identifying indicia and one of a plurality of three-dimensional designs, and being removably markable with dry-erase and wet-erase markers.
wherein the flexible label section has a plurality of widths and a plurality of thicknesses, the three-dimensional designed is defined at least in part by the plurality of widths and the plurality of thicknesses, and at least some of the plurality of widths are greater than a width of the flexible band section; and
wherein a first of the pre-printed indicia relates to a name of the infant or child associated with the reusable label, and a second of the pre-printed indicia relates to a time at which the container is to be given to the infant or child associated with the reusable label; and
wherein the flexible label section of each of the reusable labels includes a different one of the plurality of three-dimensional designs, thereby assisting identification of the container corresponding to a particular one of the infants or children.

24. The system of claim 23, wherein for each of the reusable labels, the second end includes a plurality of the second snaps, and each of the second snaps is configured to releasably engage the first snap.

25. The system of claim 23, wherein for each of the reusable labels, the pre-printed identifying indicia relates to an information category, and the flexible label section further comprises a blank space adjacent the pre-printed indicia and configured to receive removable identification markings corresponding to the information category from the dry-erase and wet-erase markers.
